(19) United States
(12) Patent Application Publication
(10) Pub. No.: US 2020/0282371 A1
(43) Pub. Date: Sep. 10, 2020

(54) MONITORING DEVICE, MONITORING METHOD, AND PROGRAM

(71) Applicant: MITSUBISHI HEAVY INDUSTRIES MACHINERY SYSTEMS, LTD., Hyogo (JP)

(72) Inventors: Yoichi MATSUSHITA, Hiroshima-shi (JP); Ryota SOGA, Hiroshima-shi (JP); Koji SHINTANI, Hiroshima-shi (JP)

(21) Appl. No.: 16/062,648

(22) PCT Filed: Aug. 31, 2017
(86) PCT No.: PCT/JP2017/031320

§ 371 Date: Jun. 15, 2018

(51) Int. Cl. B01F 15/00; B01F 15/02; B01F 7/00; B01F 7/08; B01F 15/06; G05B 15/02; G01M 99/00

(52) U.S. Cl. CPC B01F 15/00311; B01F 15/0235; B01F 15/0292; B01F 7/00891; B01F 7/088; B01F 2015/061; B01F 15/00175; B01F 15/00201; G05B 15/02; G01M 99/005; B01F 15/063

(57) ABSTRACT

A mixer control device having a function of a monitoring device acquires measurement data of monitoring target information that is obtained through measurement when a rubber material is kneaded by a mixer. In addition, the mixer control device compares the measurement data and reference data that is selected in past measurement data of the monitoring target information and performs abnormality determination. The mixer control device acquires measurement data that is measured from predetermined mixing operation initiation timing in a series of mixing operations of a rubber material in the mixer for every unit of the series of mixing operation.

### TECHNICAL FIELD

The present invention relates to a monitoring device, a monitoring method, and a program of a mixer that kneads a rubber material.

### BACKGROUND ART

A manager of a mixer that kneads a rubber material performs quality management the resultant rubber material that is produced by the mixer. In the management, the manager records and retains measurement data of a monitoring target such as a temperature of the rubber material, instantaneous power of the mixer, integral power, the number of revolutions of a rotor, a ram (floating weight) position, and a cooling water temperature. The measurement data represents a measurement data value of the monitoring target which corresponds to time. The manager monitors a mixer state by confirming the measurement data. A literature relating to the technology is disclosed in PTL 1.

### CITATION LIST

### Patent Literature

[PTL 1] Japanese Unexamined Patent Application Publication No. H6-344334

### SUMMARY OF INVENTION

### Technical Problem

However, in the mixer state monitoring as described above, the manager performs confirmation with the naked eyes and the like, and thus there is a possibility that the manager may fail to notice an abnormal state. In addition, in the mixer state monitoring with the naked eyes of the manager, there is a possibility that the manager may be unaware of a daily state variation, and thus the quality of a rubber material that is produced by the mixer may deteriorate or a deviation may occur.

Accordingly, an object of the invention is to provide a mixer monitoring device, a monitoring method, and a program which are capable of solving the above-described problem.

### Solution to Problem

According to a first aspect of the invention, there is provided a monitoring device including: a measurement data acquisition unit that acquires measurement data of monitoring target information obtained through measurement when a rubber material is kneaded by a mixer; and a determination unit that compares the measurement data and reference data that is selected in past measurement data of the monitoring target information and performs abnormality determination. The measurement data acquisition unit acquires the measurement data that is measured from predetermined mixing operation initiation timing in a series of mixing operations of the rubber material in the mixer in every unit of the series of mixing operations.

In the monitoring device, the reference data may be reference data indicating normal data that is selected in the past measurement data of the monitoring target information.

In addition, the monitoring device may further include a recording unit that records comparison data indicating a comparative relationship between the measurement data of the monitoring target information and the reference data.

In the monitoring device, the recording unit may record the comparison data for every kind of an operation mode in which the mixer kneads the rubber material.

In addition, the monitoring device may further include an output unit that outputs an abnormal state of the mixer on the basis of a result of the abnormality determination.

In addition, in the monitoring device, the measurement data may be a value indicating a statistic value calculated in unit measurement periods in which the unit measurement periods of the monitoring target information are made to be sequentially shifted from each other in response to the passage of time.

In addition, the monitoring device may further include an abnormal time prediction unit that predicts time at which the value of the measurement data exceeds a threshold value indicating abnormality on the basis of a result of the abnormality determination.

In addition, the monitoring device may further include a mixer control unit that initiates a suppression control of suppressing a value of the measurement data from exceeding a threshold value indicating abnormality on the basis of a result of the abnormality determination.

According to a second aspect of the invention, there is provided a monitoring method including: acquiring measurement data of monitoring target information obtained through measurement when a rubber material is kneaded by a mixer; comparing the measurement data and reference data that selected in past measurement data of the monitoring target information and performing abnormality determination; and acquiring the measurement data that is measured from predetermined mixing operation initiation timing in a series of mixing operations of the rubber material in the mixer in every unit of the series of mixing operations.

According to a third aspect of the invention, there is provided a program that allows a computer of a monitoring device to function as: measurement data acquisition means for acquiring measurement data of monitoring target information measured from predetermined mixing operation initiation timing in a series of mixing operations of a rubber material in a mixer in every unit of the series of mixing operations; and determination means for comparing the measurement data and reference data that is selected in past measurement data of the monitoring target information and performing abnormality determination.

### ADVANTAGEOUS EFFECTS OF INVENTION

According to the invention, it is possible to promote early confirmation of a state variation in the mixer by the manager, or it possible to perform processing, which leads to failing to notice the state variation or a reduction thereof is a relatively high accuracy. As a result, the monitoring device can suppress deterioration or a deviation of the quality of the rubber material produced by the mixer.

### BRIEF DESCRIPTION OF DRAWINGS

FIG. 1 is a block diagram illustrating a configuration of a mixer system including a mixer control device.

FIG. 2 is a schematic view of a mixer.

FIG. 3 is a view illustrating a hardware configuration of the mixer control device.

FIG. 4 is a functional block diagram of the mixer control device.

FIG. 5 is a first view illustrating a processing flow of the mixer control device.

FIG. 6 is a view illustrating a method of calculating a statistic value of a measured value indicated by measurement data.

FIG. 7 is a second view illustrating the processing flow of the mixer control device.

FIG. 8 is a view illustrating an overview of a local outlier method.

FIG. 9 is a view illustrating a rubber temperature and the degree of abnormality which correspond to a temporal transition.

FIG. 10 is a functional block diagram of a monitoring device.

### DESCRIPTION OF EMBODIMENTS

Hereinafter, description will be given of a mixer control device according to an embodiment of the invention with reference to the accompanying drawings.

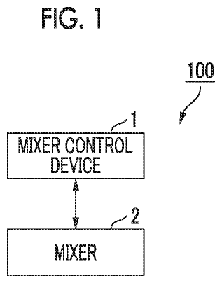

FIG. 1 is block diagram illustrating a configuration of a mixer system including the mixer control device according to this embodiment.

As illustrated in the drawing, a mixer system 100 includes a mixer control device 1 and a mixer 2 which are connected in a communication-possible manner. The mixer control device 1 according to this embodiment has a function of a monitoring device that monitors a state of the mixer 2 on an inner side. The mixer control device 1 may be embedded in the mixer 2. The mixer control device 1 is a computer that acquires at least measurement data indicating a measured value from various sensors attached to the mixer 2, and performs processing of monitoring whether or not the mixer 2 enters an abnormal state by using the measurement data. In addition, the mixer control device 1 is a computer that controls the mixer 2 and may output respective command signals to the mixer 2. The mixer 2 controls a driving target on the basis of the command signals obtained from the mixer control device 1 or another control device and the like. Examples of the driving target include a mixing rotor and the like which constitute the mixer 2.

In this embodiment, the mixer 2 kneads a rubber, silica, and other additives by rotating the mixing rotor. A rubber material that is kneaded by the mixer 2 is shaped into tires, and other rubber products. A rubber raw material, silica, carbon, a coupling agent, and the like are included in the rubber material.

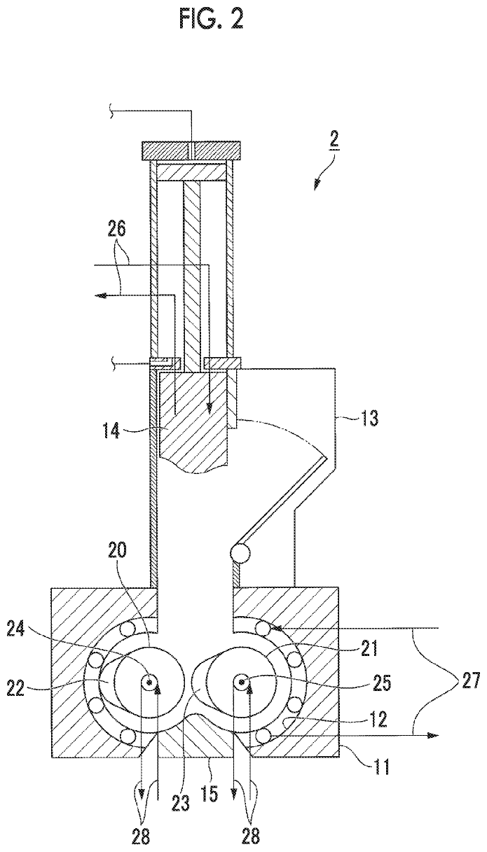

FIG. 2 is a schematic view of the mixer.

As illustrated in FIG. 2, the mixer 2 includes mixing rotors 20 and 21. The mixer 2 forms a mixing chamber 12 on an inner side of a casing 11. The mixer 2 is disposed at the inside of the mixing chamber 12 in such a manner that the mixing rotors 20 and 21 as a pair are parallel to each other. The mixing rotors 20 and 21 as a pair are rotated in directions opposite to each other by a driving source such as a motor (not illustrated). In addition, blade portions 22 and 23, which protrude toward an outer side, are respectively formed on outer surfaces of the pair of mixing rotors 20 and 21. For example, the blade portions 22 and 23 are formed to be twisted in a spiral shape with respect to axial lines 24 and 25 of the mixing rotors 20 and 21. The blade portions 22 and 23 are disposed to engage with each other due to rotation of the mixing rotor 20 and 21.

The mixer 2 is provided with a hopper 13 which communicates with the mixing chamber 12 and into which the rubber material including the rubber raw material, the additives, and the like is put, and a ram 14 that presses the rubber material, which is put into the hopper 13, into the mixing chamber 12 on an upper side.

In addition, a drop door 15, which extracts a kneaded rubber material to the outside, is attached to the bottom of the mixer 2 in a manner capable of being opened and closed.

The mixer 2 presses the rubber material, which is put through the hopper 13, into the mixing chamber 12 by the ram 14.

Next, the rubber material is kneaded by an engaging operation of the mixing rotors 20 and 21 which rotate in directions opposite to each other, and a shearing operation that occurs between the mixing rotors 20 and 21 and an inner surface of the mixing chamber 12.

In addition, the mixer 2 extracts a kneaded rubber material from the mixing chamber 12 to the outside by opening the drop door 15 provided at the bottom of the mixing chamber 12, and transfers the kneaded rubber material to another process.

Furthermore, the structure of the mixer 2 illustrated in FIG. 2 is illustrative only, and the mixer 2 may have other structures. For example, the mixer 2 may have a structure in which the rubber material is kneaded by tangenial-type rotors, and the like instead of the structure in which the rubber material is kneaded when the blade portions 22 and 23 engage with each other by rotation. In addition, the mixer 2 may include mechanism in which the rubber material is put from a slide-type open/close port other than the hopper 13. In addition, the mixer 2 may be a kneader mixer including a mechanism that inverts a mixing bath instead of the drop door as an ejection mechanism of the kneaded rubber material.

In addition, as illustrated in FIG. 2, cooling water circulates through the mixer 2. A cooling water pipeline is connected to respective portions such as the ram, the mixing chamber, and the rotors, a flow passage is formed at the inside of the respective portions, and the cooling water flows through the flow passage. The cooling water pipeline includes a first pipeline 26 through which ram cooling water for cooling the ram circulates, a second pipeline 27 through which mixing chamber cooling water for cooling the mixing chamber circulates, a third pipeline 28 through which rotor cooling water for cooling the rotors circuits, and the like.

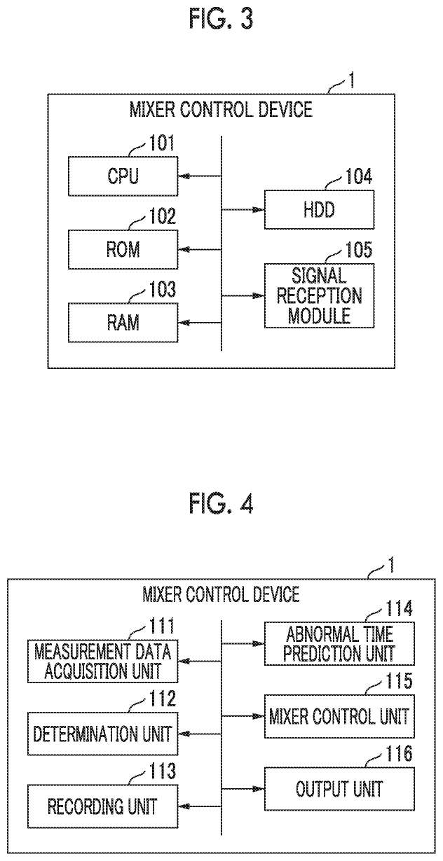

FIG. 3 is view illustrating a hardware configuration of the mixer control device according to this embodiment.

As illustrated in FIG. 3, the mixer control device 1 is a computer that including a central processing unit (CPU) 101, a read only memory (ROM) 102, a random access memory (RAM) 103, a hard disk drive (HDD) 104, and a signal reception module 105.

FIG. 4 is a functional block diagram of the mixer control device according to this embodiment.

The CPU 101 of the mixer control device 1 executes a program that is stored in an own device in advance. According to this, the mixer control device 1 includes respective configurations of a measurement data acquisition unit 111, a determination unit 112, a recording unit 113, an abnormal time prediction unit 114, a mixer control unit 115, and an output unit 116.

For example, the measurement data acquisition unit 111 acquires measurement data of monitoring target information measured from predetermined mixing operation initiation timing in a series of mixing operations of the rubber material in the mixer 2 in each unit of the series of mixing operations.

For example, the determination unit 112 performs abnormality determination by comparing the measurement data and reference data selected in past measurement data of the monitoring target information.

For example, the recording unit 113 records comparison data indicating a comparative relationship the measurement data of the monitoring target information and the reference data.

For example, the abnormal time prediction unit 114 predicts time at which a value of the measurement data exceeds a threshold value indicating abnormality on the basis of a result of abnormality determination.

For example, the mixer control unit 115 performs a typical control of the mixer 2, or a suppression control of suppressing the value of the measurement data from exceeding the threshold value indicating the abnormality on the basis of the result of the abnormality determination.

For example, the output unit 116 outputs an abnormal state of the mixer 2 on the basis of the result of the abnormality determination.

The mixer control device 1 having the function of the monitoring device includes the respective processing units, and performs at least abnormality determination of the mixer 2, and outputs the determination result. According to this, the mixer control device 1 promotes early confirmation of a state variation in the mixer 2 by a manager, or performs output of information, which leads to failing to notice the state variation or a reduction thereof in a relatively high accuracy. As a result, the mixer control device 1 suppresses deterioration a deviation of the quality of the rubber material produced by the mixer.

Furthermore, the mixer control device 1 may acquire one piece or a plurality of pieces of measurement data such as a rubber material temperature, instantaneous power of the mixer 2, integral power input to the mixer 2, the number of revolutions of a rotor, a ram (floating weight) position (a ram lift amount that is a movement amount from a reference position), a cooling water temperature (a cooling water inlet temperature, a cooling water outlet temperature, a temperature difference between the cooling water inlet temperature and the cooling water outlet temperature, and the like), the amount of cooling water, and a mixing pressure which become monitoring target information, and may perform abnormality determination on the basis of the measurement data.

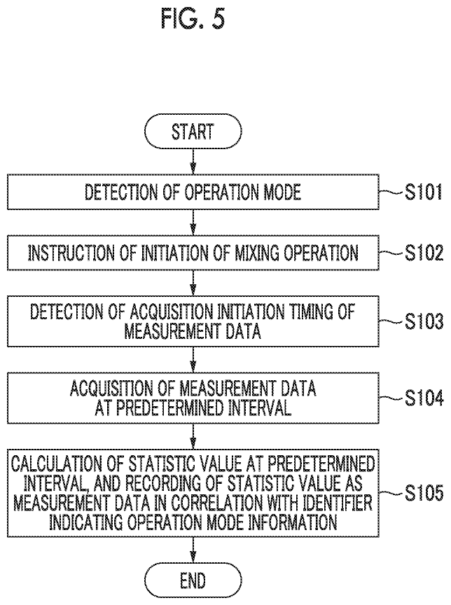

FIG. 5 is a first view illustrating a processing flow of the mixer control device according to this embodiment.

Next, description will be given of the processing flow of the mixer control device according to this embodiment.

The mixer control device 1 stores an operation mode information indicating information such as the kinds of respective material included in the rubber material to be kneaded by the mixer 2, detailed information and identification information of an operation mode of the mixer 2 that kneads the rubber material, and a capacity ratio of a volume capacity of the rubber material to the volume capacity of the mixing chamber 12 for each of a plurality of different operation modes. The manager operates operation pieces and the like of the mixer control device 1 to select and input operation mode information indicating a desired operation mode among the plurality of different operation modes. According to this, the mixer control unit 115 detects an operation mode of the mixer control device 1 (step S101). In addition, the mixer control unit 115 gives an instruction for the mixer 2 to initiate a mixing operation based on the operation mode information (step S102). Furthermore, as an example, the operation mode information includes combination information of putting timing of rubber raw materials, silica, and other additives, which are included in the rubber material, into the mixer 2, the number of revolutions of the mixing rotors per unit time, a mixing time, ram position raising and lowering timing, and the like.

The mixer control unit 115 of the control device 1 detects mixing operation initiation timing or measurement data acquisition initiation timing in the mixer 2 (step S103). The mixing operation initiation timing or the measurement data acquisition timing may be instantaneous timing at which the ram of the mixer 2 initiate to move from a predetermined standby position for a mixing operation as an example. An acquisition mode of the measurement data acquisition initiation timing may be different in accordance with the kind of the mixer 2. For example, in a case of a different mixer 2, the measurement data acquisition initiation timing may be timing at which the hopper is closed. When detecting the mixing operation initiation timing or the measurement data acquisition timing, the mixer control unit 115 determines whether or not to terminate the processing (step S104), and in a case where it is determined as non-termination, the mixer control unit 115 gives an instruction for the measurement data acquisition unit 111 to initiate measurement.

In a period in which the mixing of the rubber material by the mixer 2 is controlled, the measurement data acquisition unit 111 acquires measurement data with respect to one piece or a plurality of pieces of the above-described monitoring target information from the mixer 2 at a predetermined interval on the basis of the instruction of the mixer control unit 115 (step S105). For example, the predetermined interval may be set to several seconds, several tens of seconds, and the like. The recording unit 113 records the measurement data acquired at the predetermined interval in a storage unit such as the HDD 104 in correlation with an identifier indicating the operation mode information.

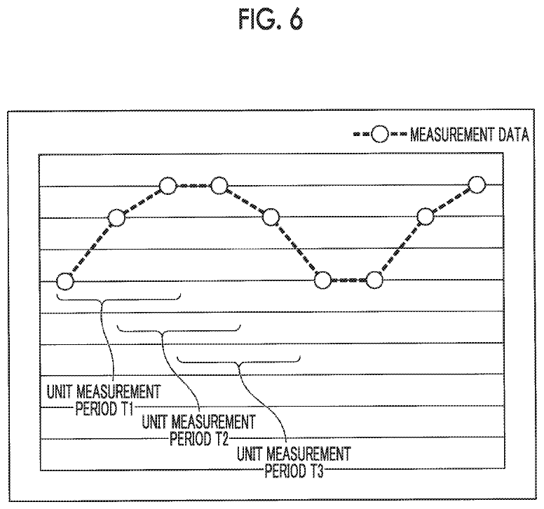

FIG. 6 is a view illustrating a method of calculating a statistic value of a measured value indicated by the measurement data.

The recording unit 113 calculates a statistic value of measured values indicated by a plurality of measurement data acquired in the unit measurement period, and records the statistic value in the storage unit such as the HDD 104 in correlation with an identifier indicating operation mode information as measurement data (step S106). The recording unit 113 records statistic values calculated in respective unit measurement periods T, in which the unit measurement periods T (T1, T2, T3, . . . ) are made to be sequentially shifted from each other in response to the passage of time as illustrated in FIG. 6, in the storage unit as sequential measurement data. The following statistic value may be an average value, the intermediate value, and the like.

Through the above-described processing, the mixer control device 1 can accumulate the measurement data of the mixer 2. The mixer control device 1 accumulates a plurality of pieces of the measurement data for every operation mode when the mixer 2 is in a normal state. That is, the mixer control device 1 records the measurement data in the storage unit whenever operating the mixer 2.

The mixer control device 1 performs detection of acquisition initiation timing of the measurement data in step S103, and makes the measurement data initiation timing be consistent in a series of respective operations from initiation to termination of the mixing operation of the mixer 2. In addition, the mixer control device 1 records a statistic value of measured values as measurement data by the processing in step S106. Through the above-described processing, the mixer control device 1 suppresses an increase in acquisition of abnormal measurement data caused by a temporal deviation in measurement data collection, and thus erroneous determination of abnormality is reduced.

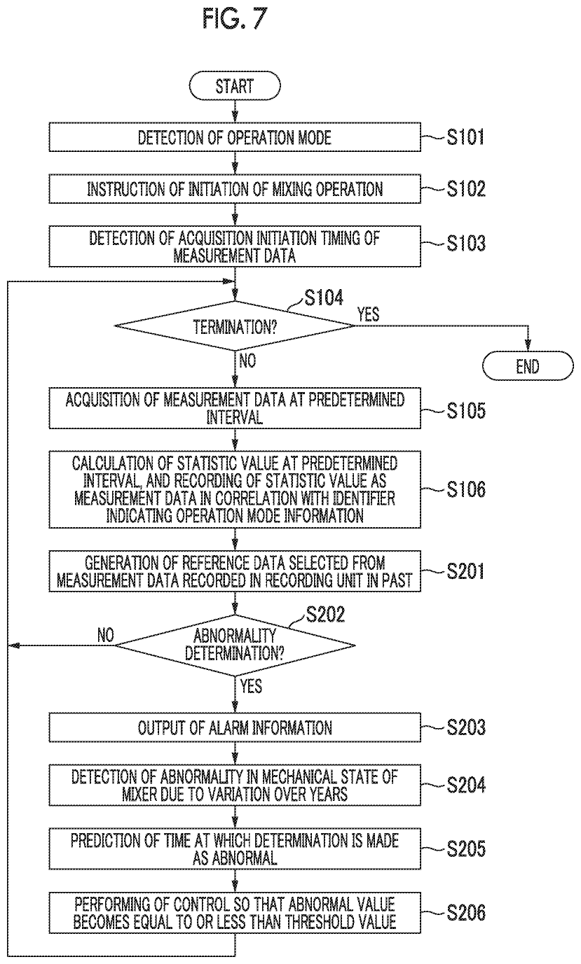

FIG. 7 is a second view illustrating the processing flow of the mixer control device according to this embodiment.

In a state of accumulating a plurality of the measurement data when the mixer 2 is in a normal state, the mixer control device 1 performs abnormality determination of the mixer 2. Furthermore, the state in which the mixer 2 is normal may be a state in a predetermined initial period in which the mixer 2 is started to be used, and the like as an example. In the abnormality determination step, the mixer control device 1 performs the processing in step S101 to step S106 in the same manner. In addition, the determination unit 112 generates reference data that is selected from measurement data that is recorded in the storage unit in the past (step S201). For example, the manager allows the mixer control device 1 to select measurement data that is used as the reference data in the measurement data that is recorded in the past. Alternatively, the determination unit 112 may specify measurement data, which is regarded as normal data in the measurement data recorded in the storage unit in the past, through arbitrary processing, and may generate the measurement data as the reference data. Furthermore, in a case where the entirety of pieces of measurement data in the past can be regarded as normal data, the determination unit 112 may select the entirety of pieces of recorded measurement data in the past as the reference data.

The determination unit 112 compares measurement data that is recorded in a current mixing operation of the mixer 2, and the reference data by using a local outlier method, and performs abnormality determination (step S202). The local outlier method is a method of determining abnormality on the basis of a data density.

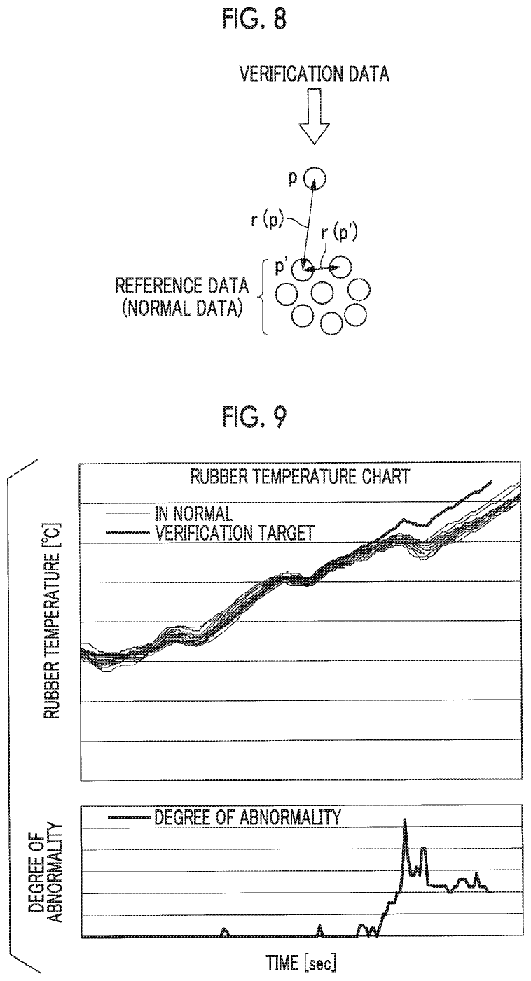

FIG. 8 is a view illustrating an outline of the local outlier method.

In the local outlier method, in a case where a distance between verification data (measurement, data that is newly measured) and the reference data (normal data) that is selected from the measurement data in the past is short, the verification data is determined as normal. On the other hand, in the local outlier method, case where the distance between the verification data and the reference data is long, the verification data is determined is abnormal.

In a case of performing the local outlier method, the determination unit 112 calculates the following Expression (1). In Expression (1), r(p) represents a distance r(p) from verification data p to reference data (p′) that is the k^{th} closest to the verification data p (in the drawing, k=1). In addition, in Expression (1) , r(p′) represents a distance r(p′) from the reference data. (p′) to another reference data that is the k^{th} closest to the reference data (p′). At this time, the degree of abnormality a(p) is expressed by the following Expression (1). In a case where the degree of abnormality a(p) is greater than 1, the determination unit 112 determines that the verification data is abnormal. Furthermore, when a value of “k” is changed, a value of the degree of abnormality a(p) that is calculated by Expression (1) also fluctuates. The value of “k” may be automatically determined by the mixer control device 1 by using a statistic method so that the degree of abnormality a(p) is appropriately calculated. The value of “k” may be set to an arbitrary value by the manager and may be input to the mixer control device 1.

$$\begin{matrix}[ Math . 1 ] & \\ a ( p ) = \frac{r ( p )}{r ( {p}^{′} )} & ( 1 )\end{matrix}$$

In a case where the degree of abnormality a is greater than 1 on the basis of the verification data, the determination unit 112 notifies the output unit 116 of abnormality. In a case of receiving the abnormality notification, the output unit 116 outputs alarm information on a monitor and the like (step S203). When receiving the abnormality notification from the determination unit 112 continuously for a predetermined number of times, or when receiving the abnormality notification for a predetermined period or longer, the output unit 116 may output the alarm information. The output unit 116 may output the alarm information with a sound other than the monitor. The recording unit 113 records the degree of abnormality a calculated by the determination unit 112 and the measurement data and the statistic value acquired by the measurement data acquisition unit 111.

The mixer control device 1 having the function of the monitoring device includes the respective processing units as described above, and automatically performs at least the abnormality determination of the mixer 2 and recording of information based on a large amount of measurement data, it is possible to promote early confirmation of a state variation in the mixer 2 by the manager, or it is possible to perform output of information, which leads to failing to notice the state variation or a reduction thereof in a relatively high accuracy. As a result, the mixer control device 1 can suppress deterioration or a deviation of the quality of the rubber material produced by the mixer.

In addition, the mixer control device 1 automatically performs recording of the information based on the large amount of measurement data per an operation mode, and thus it is possible to record a temporal transition of the measurement data in each of the operation modes. As a result, comparison with the past becomes easy. In addition, the mixer control device 1 can perform the abnormality determination in real time by using the measurement data. Accordingly, the mixer control device 1 can prevent leakage of the rubber material, in which abnormality occurs, to the subsequent process.

FIG. 9 is a view illustrating a rubber temperature and the degree of abnormality which correspond to a temporal transition.

The output unit 116 may output a state monitoring image of a graph indicating a rubber temperature corresponding to temporal transition or a graph indicating the degree of abnormality corresponding to a temporal transition as illustrated in FIG. 9 on a monitor. In addition, the output unit 116 may monitor a daily variation of the degree of abnormality included in the state monitoring image, or the degree of dissociation of verification data from the reference data, and may detect abnormality in a mechanical state of the mixer 2 due to a variation over the years (step S204). For example, the output unit 116 may monitor an increase or a decrease of the degree of abnormality as illustrated in the state monitoring image, may predict an increasing tendency of the number of times in which the degree of abnormality per unit period is equal to or greater than a threshold value, and the like, and may determine abnormality due to the variation over the years on the basis of the increasing tendency by using a predetermined calculation expression.

In addition, the abnormal time prediction unit 114 may predict time at which determination is made as abnormal on the basis of the increasing tendency of the number of times at which the degree of abnormality per unit period is equal to or greater than a threshold value (step S205). For example, the abnormal time prediction unit 114 counts the number of times at which the degree of abnormality per unit period is equal to or greater than the threshold value, and calculates future time at an intersection on the basis of a function indicating an increasing tendency along an inclination of the increase in the number of times with the passage of time, and a primary expression indicating the threshold value of the number of times. The abnormal time prediction unit 114 may output the future time as a prediction time at which determination made as abnormal. In addition, for example, the mixer control device 1 stores in advance information indicating the cause for abnormality which is assumed for every kind of monitoring target information. When predicting an abnormal time, the abnormal time prediction unit 114 may output the information indicating the cause corresponding to the kind of the monitoring target information in combination with the prediction time. For example, in a case where it is predicted that the degree of abnormality of the rubber temperature exceeds a threshold value, the abnormal time prediction unit 114 may output information of pipeline leakage of a cooling water system that is the cause and a valve site in combination with the prediction time.

When detecting and predicting that the degree of abnormality exceeds the threshold value, the determination unit 112, the output unit 116, and the abnormal time prediction unit 114 may notify the mixer control unit 115 of the result. In this case, the mixer control unit 115 may control the mixer 2 through a feedback control so that the degree of abnormality becomes equal to or less than the threshold value (step S206). According to this, the mixer control device 1 can suppress an increase in the degree of abnormality. After step S206 or in a case where the determination result in step S202 is No, in step S104, the measurement data acquisition unit 111 determines whether or not to terminate the processing. In a case of determination as non-termination, the measurement data acquisition unit 111 repetitively performs processing subsequent to step S105.

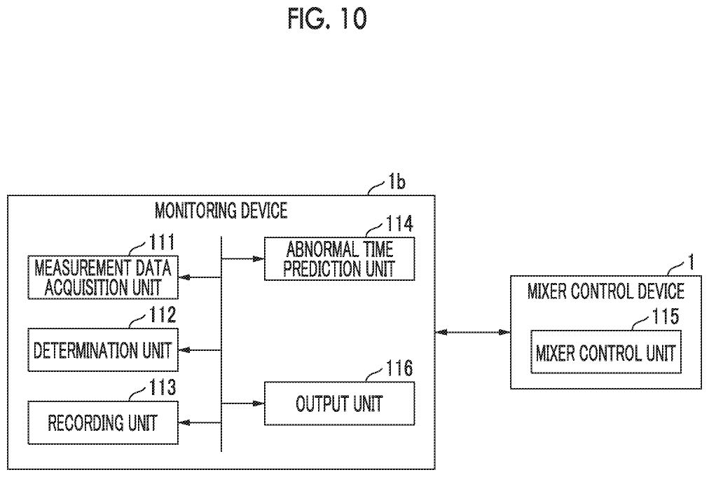

FIG. 10 is a functional block diagram of the monitoring device.

Description has been given of an aspect in which the mixer control device 1 has the function of the monitoring device 1b, but the monitoring device may be a device different from the mixer control device 1. In this case, the monitoring device 1b may have at least functions of the measurement data acquisition unit 111 and the determination unit 112. The measurement data acquisition unit 111 acquires the measurement data of the monitoring target information that is measured from predetermined mixing operation initiation timing in a series of mixing operations of the rubber material in the mixer 2 in every unit of the series of mixing operations. The determination unit 112 compares the measurement data and reference data selected in east measurement data of the monitoring target information and performs abnormality determination.

In addition, the monitoring device 1b may have functions of the recording unit 113, the abnormal time prediction unit 114, and the output unit 116. The functions of functional units are the same as described in the mixer control device 1.

In addition, in a case of controlling the mixer 2 so that the degree of abnormality is equal to or less than the threshold value through the feedback control, the monitoring device 1b gives an instruction for the mixer control unit 115 of the mixer control device 1 that is connected thereto through communication to make the degree of abnormality be equal to or less than the threshold value. In this case, the mixer control unit 115 of the mixer control device 1 performs the feedback control.

Furthermore, the mixer control device 1 or the monitoring device 1b includes a computer system on an inner side. In addition, a program that allows the mixer control device 1 or the monitoring device 1b to perform the above-described processing is stored in a computer-readable recording medium of the mixer control device 1, and when a computer of the mixer control device 1 or the monitoring device 1b reads out and executes the program, the above-described processing is performed. Here, the computer-readable recording medium represents a magnetic disk, a magneto-optical disc, a CD-ROM, a DVD-RCM, a semiconductor memory, and the like. In addition, the computer program may be transferred to a computer through communication line, and the computer to which the computer program is transferred may execute the program.

In addition, the program may be configured to realize a part of the functions of the above-described processing units. In addition, the program may be a so-called differential file (differential program) that can realize the above-described functions in combination with a program that is stored in the computer system in advance.

### INDUSTRIAL APPLICABILITY

The present invention relates to a monitoring device of a mixer that kneads a rubber material, a monitoring method, and a program.

### REFERENCE SIGNS LIST

1: Mixer control device

1b: Monitoring device

2: Mixer

111: Measurement data acquisition unit

112: Determination unit

113: Recording unit

114: Abnormal time prediction unit

115: Mixer control unit

116: Output unit

1. A monitoring device, comprising:
a measurement data acquisition unit that acquires measurement data of monitoring target information obtained through measurement when a rubber material is kneaded by a mixer; and
a determination unit that compares the measurement data and reference data that is selected in past measurement data of the monitoring target information and performs abnormality determination,
wherein the measurement data acquisition unit acquires the measurement data that is measured from predetermined mixing operation initiation timing in a series of mixing operations of the rubber material in the mixer in every unit of the series of mixing operations.

2. The monitoring device according to claim 1,
wherein the reference data is reference data indicating normal data that is selected in the past measurement data of the monitoring target information.

3. The monitoring device according to claim 1, further comprising:
a recording unit that records comparison data indicating a comparative relationship between the measurement data of the monitoring target information and the reference data.

4. The monitoring device according to claim 3,
wherein the recording unit records the comparison data for every kind of an operation mode in which the mixer kneads the rubber material.

5. The monitoring device according to claim 1, further comprising:
an output unit that outputs an abnormal state of the mixer on the basis of a result of the abnormality determination.

6. The monitoring device according to claim 1,
wherein the measurement data is a value indicating a statistic value calculated in unit measurement periods in which the unit measurement periods of the monitoring target information are made to be sequentially shifted from each other in response to the passage of time.

7. The monitoring device according to claim 1, further comprising:
an abnormal time prediction unit that predicts time at which the value of the measurement data exceeds a threshold value indicating abnormality on the basis of a result of the abnormality determination.

8. The monitoring device according to claim 1, further comprising:
a mixer control unit that initiates a suppression control of suppressing a value of the measurement data from exceeding a threshold value indicating abnormality on the basis of a result of the abnormality determination.

9. A monitoring method, comprising:
acquiring measurement data of monitoring target information obtained through measurement when a rubber material is kneaded by a mixer;
comparing the measurement data and reference data that is selected in past measurement data of the monitoring target information and performing abnormality determination; and
acquiring the measurement data that is measured from predetermined mixing operation initiation timing in a series of mixing operations of the rubber material in the mixer in every unit of the series of mixing operations.

10. A program that allows a computer of a monitoring device to function as:
measurement data acquisition means for acquiring measurement data of monitoring target information measured from predetermined mixing operation initiation timing in a series of mixing operations of a rubber material in a mixer in every unit of the series of mixing operations; and
determination means for comparing the measurement data and reference data that is selected in past measurement data of the monitoring target information and performing abnormality determination.
